(19) United States
(12) Patent Application Publication
(10) Pub. No.: US 2005/0121480 A1
(43) Pub. Date: Jun. 9, 2005

(54) Systems and methods for providing a self-arresting device

(76) Inventor: Erik Cooley, Layton, UT (US)

Correspondence Address: David B. Tingey;KIRTON & McCONKIE, Suite 1800, 60 East South Temple, Salt Lake City, UT, 84111, US

(21) Appl. No.: 10/941,209

(22) Filed: Sep. 15, 2004

Related U.S. Application Data
(60) Provisional application No. 60/503,139, filed on Sep. 15, 2003.
(60) Provisional application No. 60/528,114, filed on Dec. 8, 2003.

(51) Int. Cl. A45C 1/00; A45F 3/14; A44C 5/18; A47F 5/08; F41B 13/04; B26B 29/02

(52) U.S. Cl. 224/218; 224/219; 224/221; 224/232

(57) ABSTRACT

The present invention relates to systems and methods for providing a self arresting device. In particular, the present invention relates to providing a self-arresting device configured for use on snowy/icy slopes, which may be operated with one or more hands and includes a handle and a head having a surface area to self-arrest. An arm or wrist brace may be coupled to the head and/or handle and configured for selective coupling to a user to retain the self-arresting device by the user. Further, the device may selectively transition between a non-use position and a useable position.

### RELATED APPLICATIONS

This application claims priority to U.S. Provisional Patent Application Ser. No. 60/503,139 filed Sep. 15, 2003, entitled SYSTEMS AND METHODS FOR PROVIDING A SELF-ARRESTING DEVICE, and to U.S. Provisional Patent Application Ser. No. 60/528,114 filed Dec. 8, 2003, entitled SYSTEMS AND METHODS FOR PROVIDING A SELF-ARRESTING DEVICE.

### BACKGROUND OF THE INVENTION

1. Field of the Invention

The present invention relates to systems and methods for providing a self-arresting device. In particular, the present invention relates to providing a self-arresting device configured for use on snowy/icy slopes.

2. Background and Related Art

Skiers currently have the option of using self-arresting ski poles. While this is a viable alternative for skiers, utilization of ski poles is not practical for snowboarders. Accordingly, snowboarders typically don't have anything in their hands when they snowboard. Instead, the snowboarders use their free hands to occasionally drag the snow when they make their turns.

Thus, while self-arresting devices currently exist that are used to allow a skier to self arrest, a viable option for snowboarders does not exist. Accordingly, it would be an improvement in the art to augment or even replace current techniques with other techniques.

### SUMMARY OF THE INVENTION

The present invention relates to systems and methods for providing a self-arresting device. In particular, the present invention relates to providing a self-arresting device configured for use on snowy/icy slopes.

Implementation of the present invention takes place in association with a self-arresting device for use on icy/snowy slopes. In particular, the present invention relates to systems and methods for allowing a user (e.g., a snow boarder) on a steep icy/snowy slope to stop the user as he/she is falling or otherwise uncontrollably sliding down the slope. The self-arresting device includes a handle that is coupled to a head, which is configured to dig into the steep icy/snowy slope, an arm brace that prevents the device from escaping the user's hand while in use, and straps to further couple the device to the user. The head is comprised of a material that can withstand the load exerted onto the self-arresting device (e.g., high strength aluminum, steel, graphite, fiberglass, a high strength polymer, another metal, a metal alloy, or another material). The arm brace also comprises a material that can withstand a load exerted on the self-arresting device (e.g., spring stainless steel, high strength aluminum, steel, graphite, fiberglass, a high strength polymer, another metal, a metal alloy, or another material). Thus, a snow-boarder is able to self-arrest or otherwise stop himself/herself by placing force on the device, causing the head to dig into the icy/snowy slope and stop the user's fall or uncontrollable slide and/or reduce injury.

While the methods and processes of the present invention have proven to be particularly useful in the area of providing a self-arresting device for snowboarders, those skilled in the art can appreciate that the methods and processes can be used in a variety of different applications and in a variety of different areas of manufacture to yield a self-arresting device for a user, such as a hiker, climber, etc.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative self-arresting device in accordance with an embodiment of the present invention;

FIG. 2 illustrates the representative device coupled to a user;

FIG. 3 illustrates another representative self-arresting device in accordance with an embodiment of the present invention;

FIG. 4 illustrates a top view of the representative embodiment of FIG. 3;

FIG. 5A illustrates another representative self-arresting device in accordance with an embodiment of the present invention;

FIG. 5B illustrates the head configuration of the embodiment of FIG. 5A;

FIG. 6 illustrates another representative self-arresting device in accordance with an embodiment of the present invention;

FIG. 7 illustrates another representative self-arresting device in accordance with an embodiment of the present invention;

FIG. 8 illustrates the representative embodiment of FIG. 7 without an arm brace;

FIG. 9 illustrates another representative self-arresting device in accordance with an embodiment of the present invention; and

FIG. 10 illustrates another representative self-arresting device in accordance with an embodiment of the present invention.

### DETAILED DESCRIPTION OF THE INVENTION

The present invention relates to systems and methods for providing a self-arresting device. In particular, the present invention relates to providing a self-arresting device configured for use on snowy/icy slopes.

In the disclosure and in the claims the term “self-arresting” shall refer to slowing down or stopping oneself.

Embodiments of the present invention take place in association with a self-arresting device for use on icy/snowy slopes. In particular, some embodiments of the present invention relate to systems and methods for allowing a user (e.g., a snow boarder, hiker, etc.) on a steep icy/snowy slope to stop himself/herself as he/she is falling down the slope. In at least some embodiments, the self-arresting device includes a handle that is coupled to a head, which is configured to dig into the steep icy/snowy slope, an arm brace that prevents the device from escaping the user's hand while in use, and straps to further couple the device to the user. In one embodiment the head is comprised of high strength aluminum and the arm brace comprises spring stainless steel. Thus, a user when he/she is going down an icy/snowy slope in the back country, the user is able to self-arrest or otherwise stop himself/herself by placing force on the device, causing the head to dig into the slope and stop the user's fall or uncontrollable slide and/or reduce injury.

Skiers and snowboarders participate in snow related activities year-round if the weather conditions permit. Much of the activity is performed at developed ski and snowboard resorts where the terrain is fairly benign and the risk of injury is minimized. In addition, hikers are usually out in the mountains early in the spring and continue their hiking activities until late fall. This hiking activity is usually done on conditioned hiking trails where risk of injury may only be a sprained ankle or a broken bone of some kind. However, an ever increasing number of individuals can be found skiing, snowboarding, hiking or otherwise endeavoring dangerous snow and/or ice covered areas where the conditions constitute extreme risk of severe injury or even death.

One type of this extreme risk results when skiers, snowboarders or hikers venture onto steep snow-covered slopes without adequate means to stop themselves if they should somehow fall and begin to uncontrollably slide down the mountain.

Areas where this dangerous terrain exists can be within ski area boundaries or just outside of ski area boundaries. For example, where the skier or snowboarder may use the ski lift to get as high on the mountain as possible, then begin hiking even higher (across ski area boundaries) to the more steep and extreme areas of the mountain. In addition, dangerous areas are even more abundant in almost all mountainous areas around the world. These areas are accessed by skiers, snowboarders and hikers alike.

Death or serious injury is usually caused when a skier, snowboarder, or hiker falls while attempting to climb up or descend down a slope. Some falls are as harmless as losing one's balance and falling over onto the slope. This type of fall, while usually not dangerous in other less extreme conditions, can escalate into a life-threatening situation within seconds. This occurs, for example, when the falling person begins to uncontrollably slide on the slick slope and has no way to stop (arrest) himself/herself from this slide. Speed increases rapidly, often resulting in tumbling, rolling, bouncing, and then breaking of bones and/or tearing of muscles. If the slope ends in a cliff, the falling person usually slides off the cliff at high speeds and is launched into the air, only to meet with death upon impact. If the slope ends in rock fields or trees, the falling person can be seriously injured or killed upon impact with any of these objects. If the snowfield is littered with trees, rocks, ice chunks, etc. a sliding person can hit the debris or slide over it, once again causing injury or death.

This risk of injury and death can be brought about and increased by the presence of one or more of the following factors: (i) steep snow-covered terrain; (ii) hard and compacted snow conditions; (iii) the presence of ice; (iv) terrain at the end of the snowfield; and/or (v) debris scattered within the snowfield.

Embodiments of the present invention enable users to stop or slow down when falling or sliding down a snow or ice covered mountain, thereby helping them avoid serious injury and death. This process of stopping while falling or sliding is typically called a “self arrest”. At least some embodiments of the present invention can be operated effectively with one hand. Other embodiments include having the user employ a self-arresting device with both hands independently. Further, some embodiments include a wrist or forearm brace that allows significant pressure to be brought to bear on the device, thereby bringing the sliding person to a stop. In some embodiments the brace is detachable to enable an interchange of components. Further, at least some devices of the present invention are small, compact and not bulky. Moreover, in at least some embodiments, no long shaft, which is normally associated with traditional ice axes or self-arresting ski poles, is included to further allow the user freedom of movement.

A device of the present invention may be used by snowboarders, hikers, climbers, etc. who choose not to carry an ice axe but still desire safety and desire a device that is lighter and more compact than contemporary technologies. In some embodiments, the device is used by snowboarders as it fits easily into the user's hand and allows the user to still have the use of his/her hands if desired, until the device is needed in the event of a fall or a slide.

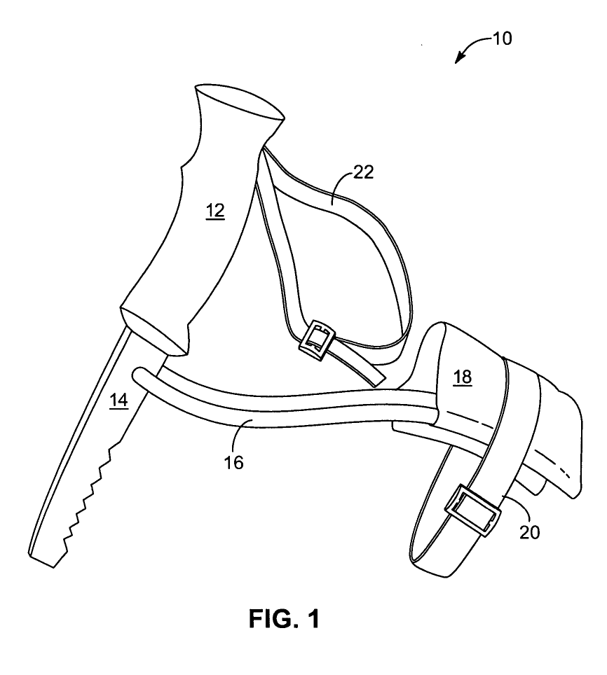

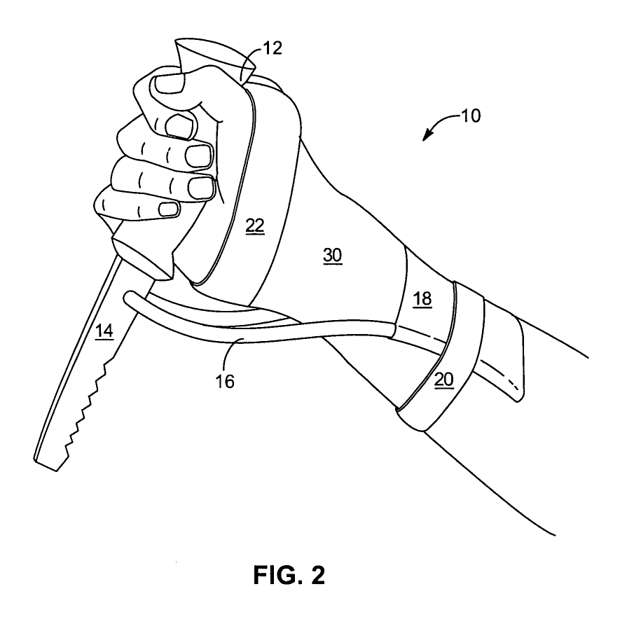

With reference now to FIG. 1, a representative self-arresting device is provided. In FIG. 1, device 10 includes handle 12, head 14, protrusions 16, pad 18, strap 20, and strap 22. In the illustrated embodiment, handle 12 is easily gripped by the user's hand. A wrist strap 22 extends from the handle and is configured to wrap around the wrist of user 30 (FIG. 2). Head 14 may include a variety of different configurations, such as a pick configuration (FIG. 1), an adze configuration, a multiple pick or surface configuration, a claw configuration, and/or another configuration to aid in self-arresting. Those skilled in the art will appreciate that embodiments of the present invention embrace a variety of head configurations, including any type of geometric configuration that provides a surface area for use in self-arresting.

In the illustrated embodiment, a portion of head 14 extends into the handle, giving device 10 increased strength. In another embodiment, handle 12 and head 14 are a single component. A forearm brace extends from head 14 and in the illustrated embodiment includes protrusions 16, pad 18, and strap 20. In the illustrated embodiment, protrusions 16 are pivotably coupled to head 14 to enable head 14 to transition between a non-use position to a ready or use position. In the non-use position, the wrist brace may fold down against the blade, allowing it to lay flat (more compact) for packing, carrying, or storing or for keeping the blade out of the way when snowboarding, hiking, climbing or otherwise endeavoring. When device 10 is coupled to the user, but is in a non-use position, the snowboarder may continue to freely use his/her hands as needed or desired, and can quickly grab onto handle 12 when needed. In some embodiments, the forearm or wrist brace is detachable to allow the user to operate the device without the brace if desired. Pad 18 is coupled to protrusions 16, thereby padding the arm of the user 30 (FIG. 2). Pad 18 diffuses the force of a slide/self-arrest along a greater portion of the user's arm, protecting the arm against bruising or breaking when the device is engaged against or into the snow or ice. In the illustrated embodiment, strap 20 is coupled to wrist pad 18, allowing the user to secure the device to his/her arm so that the user's hands can remain free until the device is needed for safety. Further straps 20 and/or 22 facilitate placing device 10 in a ready position.

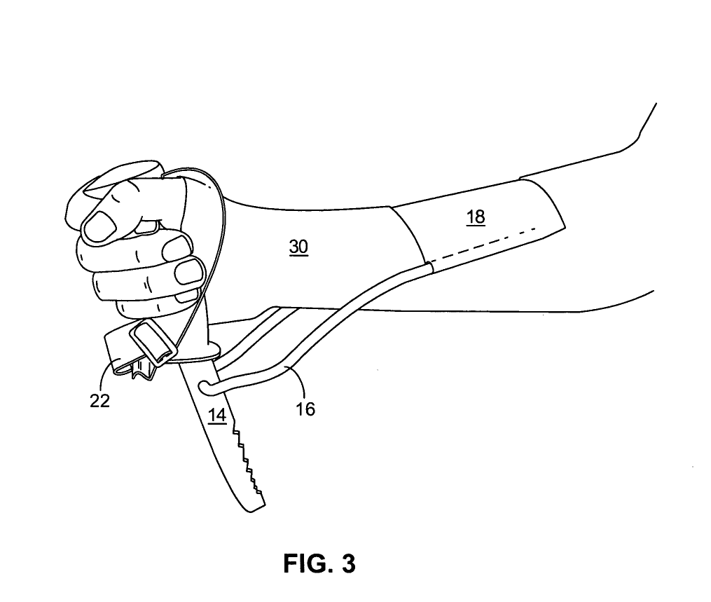

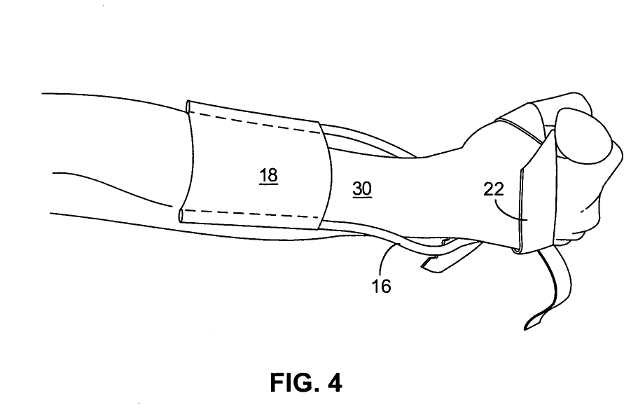

In some embodiments, device 10 is a portable, collapsible self-arresting device that may be packed in a hiker's or snowboarder's backpack, attached to the outside of a backpack, stuck into a pocket, etc. When the user of the device comes upon a snow or ice field where safety from falling and uncontrollably sliding is a concern, the user removes the device from where it is being stored/carried and quickly protects himself/herself by coupling the device onto the user's arm and/or hand, such as is illustrated in FIG. 2. Utilization of device 10 can allow user 30 to feel more protected from the effects of uncontrollably slipping or sliding on the snow or ice. User 30 may then proceed on to steeper terrain, for example, where the user would not be able to self-arrest without device 10. In FIGS. 3-4 another representative embodiment is illustrated in accordance with the present invention, wherein the embodiment of FIGS. 3-4 does not include a strap coupled to pad 18.

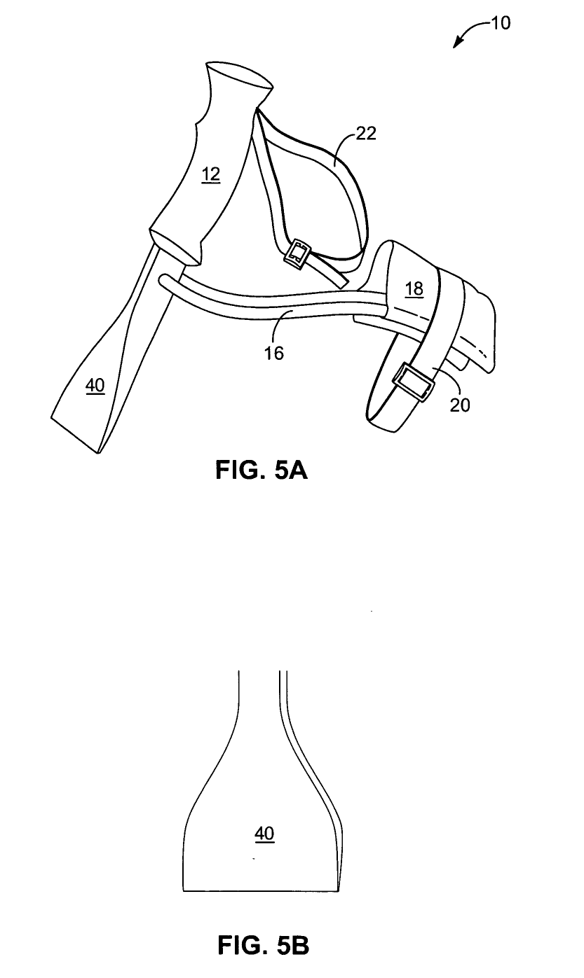

As provided above, embodiments of the present invention embrace a variety of configurations for a self-arresting device head. For example, with reference now to FIGS. 5A-5B, a blade or adze configuration is illustrated as head 40. The adze configuration allows for increased surface area to self-arrest. Alternatively, the pick configuration of head 14 (FIG. 1) allows increased penetration into the snow/ice.

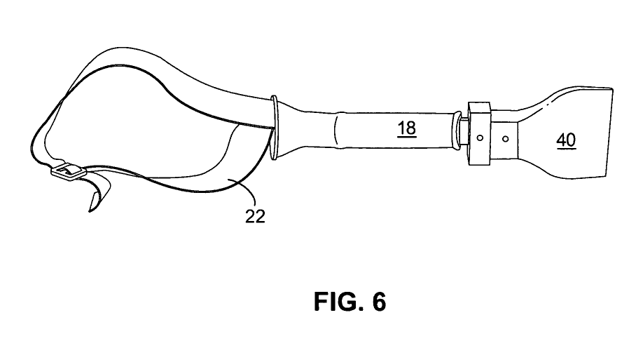

With reference now to FIG. 6 another embodiment is illustrated. In some embodiments, the head of the self-arresting device is selectively detachable to allow a user to determine which head to use. In some environments it is advantageous to have a head penetrate the snow/ice surface to self-arrest, whereas other environments allow for self-arresting based upon friction caused by force on a surface area.

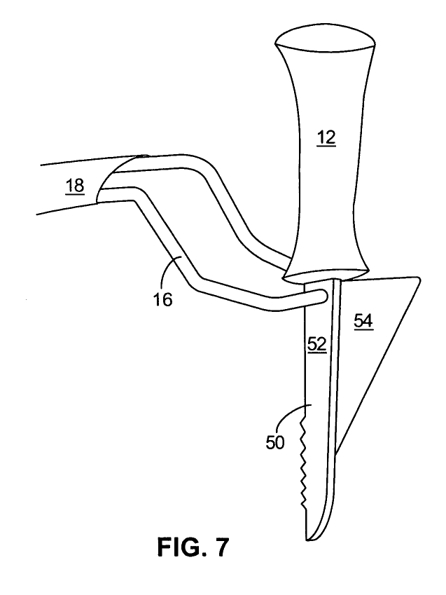

With reference now to FIG. 7, another embodiment is illustrated. In FIG. 7, the illustrated self-arresting device includes handle 12, head 50, protrusions 16, and pad 18. As discussed above, a head may include a variety of different configurations. For example, head 50 includes a pick configuration portion 52 and an adze configuration portion 54. For example, in at least one embodiment, portion 52 provides increased penetration, while portion 54 provides increased surface area to aide in the process to self-arrest. In the illustrated embodiment, handle 12 is easily gripped by the user's hand. A wrist strap (not shown) may extend from the handle and be configured to wrap around the wrist of a user.

In at least some embodiments, a portion of head 50 extends into or the length of handle 12, giving the self-arresting device increased strength. In another embodiment, handle 12 and head 50 are a single component. A forearm brace may extends from head 50 or handle 12, and may include protrusions 16, pad 18, and one or more straps (not shown). In at least some embodiments, protrusions 16 are pivotably coupled to head 50 to enable head 50 to transition between a non-use position to a ready or use position.

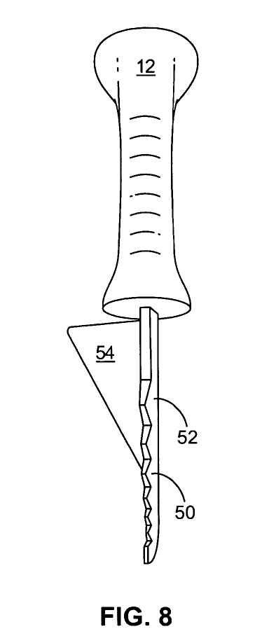

In some embodiments, the forearm or wrist brace is detachable to allow the user to operate the device without the brace if desired. For example, with reference to FIG. 8 the embodiment of FIG. 7 is provided without an arm brace.

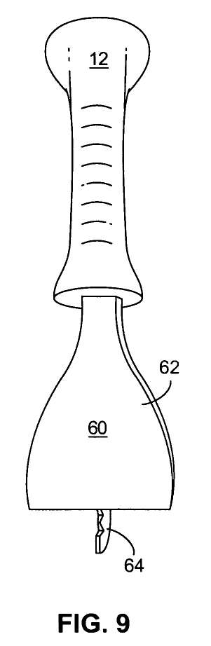

In accordance with embodiments of the present invention, a head of a self-arresting device may include a variety of configurations or combinations of configurations. For example, with reference now to FIG. 9, another representative embodiment is illustrated. In FIG. 9, the illustrated self-arresting device includes handle 12 and head 60, which includes an adze configuration portion 62 and a pick configuration portion 64. For example, in at least one embodiment, portion 64 provides increased penetration, while portion 62 provides increased surface area to aide in the process to self-arrest. In the illustrated embodiment, handle 12 is easily gripped by the user's hand. A wrist strap (not shown) may extend from the handle and be configured to wrap around the wrist of a user.

In at least some embodiments, a portion of head 60 extends into or the length of handle 12, giving the self-arresting device increased strength. In another embodiment, handle 12 and head 60 are a single component. A forearm brace may extends from head 60 or handle 12, and may include protrusions, a pad, and one or more straps. In at least some embodiments, protrusions 16 are pivotably coupled to head 60 to enable head 60 to transition between a non-use position to a ready or use position. In some further embodiments, the forearm or wrist brace is detachable to allow the user to operate the device without the brace if desired.

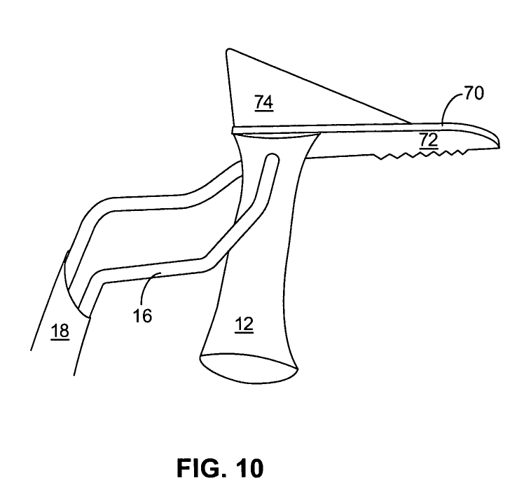

In FIG. 10, the illustrated self-arresting device includes handle 12, head 70, protrusions 16, and pad 18. Head 70 includes a pick configuration portion 72 and an adze configuration portion 74. For example, in at least one embodiment, portion 72 provides increased penetration, while portion 74 provides additional penetration and/or increased surface area to aide in the process to self-arrest. In the illustrated embodiment, handle 12 is easily gripped by the user's hand. A wrist strap (not shown) may extend from the handle and be configured to wrap around the wrist of a user.

In at least some embodiments, a portion of head 70 extends into or down the length of handle 12, giving the self-arresting device increased strength. In another embodiment, handle 12 and head 70 are a single component. A forearm brace may extend from head 70 or handle 12, and may include protrusions 16, pad 18, and one or more straps (not shown). In at least some embodiments, protrusions 16 are pivotably coupled to handle 12 to enable handle 12 to transition between a non-use position to a ready or use position. In some embodiments, the forearm or wrist brace is detachable to allow the user to operate the device without the brace if desired.

In accordance with embodiments of the present invention, the head and handle portions of a self-arresting device may be coupled in a variety of different locations. For example, in some embodiments the head is in a parallel configuration in association with the handle (as illustrated in FIG. 9). In other embodiments, the head is in a transverse configuration in association with the handle (as illustrated in FIG. 10). Further, in some embodiments of the present invention, the head extends from or is coupled to a bottom surface of the handle (as illustrated in FIG. 9). In other embodiments, the head extends from or is coupled to another portion of the handle, such as a top surface (as illustrated in FIG. 10).

Thus, as discussed herein, the embodiments of the present invention embrace systems and methods for providing a self-arresting device. In particular, the present invention relates to providing a self-arresting device configured for use on snowy/icy slopes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A self-arresting device comprising:
a handle portion configured to be selectively received by a user's hand; and
a head portion coupled to the handle portion, wherein the head portion includes a configuration having a surface area that selectively cuts into an incline upon placement of a force biasing toward the incline to cause the user to self-arrest with only the use of one hand.

2. A self-arresting device as recited in claim 1, further comprising a strap coupling the user's hand to the handle portion.

3. A self-arresting device as recited in claim 1, further comprising a brace system coupled to at least one of (i) the handle portion and (ii) the head portion, and wherein the brace system is further coupled to the user and configured to retain the self-arresting device coupled to the user during the self-arrest.

4. A self-arresting device as recited in claim 3, wherein the brace system is pivotably coupled to at least one of (i) the handle portion and (ii) the head portion to enable the handle and head portions of the device to transition between a non-engaged position and an engaged position.

5. A self-arresting device as recited in claim 4, wherein the brace system is detachable from at least one of (i) the handle portion and (ii) the head portion to enable an interchange of one or more components.

6. A self-arresting device as recited in claim 4, wherein the brace system is coupled to the user at the user's forearm.

7. A self-arresting device as recited in claim 1, wherein the device comprises at least one of:
(i) a spring stainless steel;
(ii) a high strength aluminum;
(iii) steel;
(iv) graphite;
(v) fiberglass;
(vi) a high strength polymer; and
(vii) a metal alloy.

8. A self-arresting device as recited in claim 1, wherein the user is one of:
(i) a snowboarder;
(ii) a hiker; and
(iii) a climber.

9. A self-arresting device as recited in claim 1, wherein the configuration comprise at least one of:
(i) a pick configuration;
(ii) an adze configuration;
(iii) a multiple pick configuration; and
(iv) a claw configuration.

10. A self-arresting device as recited in claim 1, wherein a portion of the head portion extends through the handle portion.

11. A self-arresting device as recited in claim 1, wherein the head portion is in one of (i) an aligned configuration and (ii) a transverse configuration with respect to the handle portion.

12. A method for self-arresting, the method comprising:
providing a self-arresting device having a handle portion and a head portion, the head portion having a configuration that includes a surface area;
receiving the handle portion at a user's hand;
providing a force that biases the head portion toward an incline to cut into the incline and cause the user to self-arrest by using only one hand; and
preventing the handle from escaping from the user's hand during the self-arrest.

13. A method for self-arresting as recited in claim 12, wherein the step for preventing the handle from escaping comprises using a strap to couple the user's hand with the handle portion.

14. A method for self-arresting as recited in claim 12, wherein the step for preventing the handle from escaping comprises using a brace system to couple the user's forearm to the self-arresting device.

15. A method for self-arresting as recited in claim 14, wherein the brace system is pivotably coupled to at least one of (i) the handle portion and (ii) the head portion.

16. A method for self-arresting as recited in claim 15, wherein the step for receiving the handle portion at a user's hand comprises selectively transitioning the handle and head portions of the device to transition between a non-engaged position and an engaged position.

17. A method for self-arresting as recited in claim 12, wherein the head portion is detachable from the brace system to selectively couple a desired head to the device.

18. A method for use by a snowboarder to self-arrest, the method comprising:
providing a self-arresting device having a handle portion and a head portion, the head portion having a configuration that includes a surface area;
receiving the handle portion at a snowboarder's hand;
selectively providing a force that biases the head portion toward an incline to cut into the incline and cause the snowboarder to self-arrest; and
preventing the handle from escaping from the snowboarder's hand during the self-arrest by utilizing a brace system that couples the snowboarder's forearm to the device, and wherein the brace system allows the snowboarder to selectively transition the device between a non-engaged position when the device is not in use by the snowboarder and an engaged position when the device is in use by the snowboarder.

19. A method for self-arresting as recited in claim 18, wherein the step for preventing the handle from escaping further comprises using a strap to couple the snowboarder's hand with the handle portion.

20. A method as recited in claim 18, further comprising:
providing a second self-arresting device having a handle portion and a head portion, the head portion of the second device having a configuration that includes a surface area; and
receiving the handle portion of the second device at the snowboarder's other hand, and wherein the step for selectively providing a force further comprises providing a second force that biases the head portion of the second device toward the incline to cut into the incline and further cause the snowboarder to self-arrest.
